(19) United States
(12) Patent Application Publication
(10) Pub. No.: US 2022/0127408 A1
(43) Pub. Date: Apr. 28, 2022

(54) METHOD FOR PREPARING NOVEL NATURAL OIL BASED HIGH TEMPERATURE ISOCYANURATE CONTAINING POLYURETHANE THERMOSETTING RESINS

(71) Applicant: MCPU Polymer Engineering, LLC, Corona, CA (US)

(72) Inventors: Thomas M. Garrett, Corona, CA (US); Xian Xian Du, Pittsburg, KS (US)

(73) Assignee: MCPU Polymer Engineering, LLC, Corona, CA (US)

(21) Appl. No.: 17/396,669

(22) Filed: Aug. 7, 2021

Related U.S. Application Data
(63) Continuation of application No. 14/696,865, filed on Apr. 27, 2015.

(51) Int. Cl. C08G 18/36; C08G 18/76; C08G 18/20; C08G 18/32; C08G 18/10; C08G 18/48

(52) U.S. Cl. CPC C08G 18/36; C08G 18/7692; C08G 18/2027; C08G 18/4829; C08G 18/10; C08G 18/7664; C08G 18/7671; C08G 18/3203

(57) ABSTRACT

Soy-based high temperature products, or thermoset resins, are produced by solvent free polymerization of soy polyols and polyisocyanates at room temperature. The ratio of isocyanate equivalents to polyol equivalent used in the synthesis is greater than or equal to 3. The invented soy-based products are polyisocyanurate solid materials with excellent stability at high temperature. Heat resistance of the material is influenced by ratio of soy polyol and polyisocyanate.

### CROSS-REFERENCE TO RELATED APPLICATIONS

This application claims priority to U.S. Provisional Application No. 61/985,719, filed on Apr. 29, 2014, and is a continuation of U.S. patent application Ser. No. 14/696,865, filed Apr. 27, 2015, the disclosures of which are hereby expressly incorporated by reference in their entirety and are hereby expressly made a portion of this application.

### BACKGROUND OF THE INVENTION

The present invention relates to high temperature stable polymeric material and specifically to bio-based high temperature materials and more specifically to solvent free polymerization of soy polyols and soy polyisocyanates into soy-polyisocyanurate solid materials. The heat resistance of the resultant soy-polyisocyanurate material influenced by the ration of soy polyol and polyisocyanate, but examples show the invention can be stable to 250° C. (482° F.).

High temperature organic materials are organic polymers and polymer composites that exhibit the property of stability at high temperatures. Such high temperature organic materials are commonly stable at about 177° C. (350° F.) in air (M. R. Tant, J. W. Connell and H. L. N. McManus; High-Temperature Properties and Applications of Polymeric Materials, ACS Symposium Series 603, 1995). Due to their stability at high temperatures, bio-based high temperature materials are widely demanded in many high technology areas, such as but not limited to high speed aircraft, turbine engines, electronics and photonics.

High temperature organic materials are commonly aromatic and heterocyclic polymers. Exemplary polymers include high temperature epoxies (U.S. Pat. Nos. 7,560,501, 7,156,559; 4,331,582), high temperature polyimides (U.S. Pat. Nos. 7,015,260; 6,911,519; 5,338,827; 5,132,395; 4,477,648), and high temperature cyanate esters (U.S. Pat. Nos. 8,530,693; 6,080,836; 4,370,462).

The high temperature organic materials of the present invention are soybean oil-based isocyanurates, or soy isocyanurate polymers. The isocyanurate is a thermally stable compound. Dissociation temperature of the isocyanurate is about 350° C. (Materials Science, 2011, Vol. 17, No. 3, pp249-253; Macromolecules, 1987, 20, 2077-2083; Polymer Degradation and Stability, 2002, 78, pp 1-5).

The isocyanurate is a heterocyclic compound that is obtained from a self-addition reaction of the isocyanates. For example, isocyanates can react with themselves, so as to form trimers called isocyanurates, such as is illustrated below in Formula I. Szycher's Handbook of Polyurethane (Edited by Michael Szycher) teaches that both aliphatic and aromatic diisocyanates undergo trimerization reaction to form the trifunctional isocyanurates (Formula I).

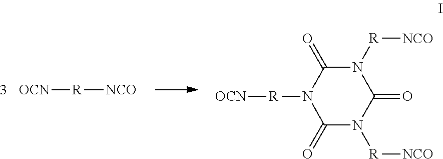

U.S. Pat. Nos. 3,716,535; 3,980,594; 4,454,317; 4,518,761; 4,632,989; 5,264,572; 5,770,671; 5,955,609; 6,635,761; 7,001,973; 7,030,266 and 8,119,799 describe processes for preparing isocyanurates from aliphatic diisocyanates and aromatic (e.g., phenyl) isocyanates.

Isocyanurates have been used in polyurethane coatings and polyurethane foams. U.S. Pat. No. 7,939,598 and The Huntsman Polyurethane Book (edited by Stephen Lee) describe use of a trifunctional isocyanurate (Formula I, above) as a crosslinker component in polyurethane coating materials and coatings. U.S. Pat. Nos. 4,780,485; 5,095,042; 5,789,458; 6,638,989 and 7,579,068 disclose processes for forming isocyanurates within rigid polyurethane foams by using excess isocyanates. Furthermore, U.S. Pat. No. 6,384,177 describes a process for forming isocyanurates in flexible polyurethane foams by using excess isocyanates.

Bio based isocyanurates are already known in the art to be used to fabricate polyurethane coatings and polyurethane foams. U.S. Pat. No. 8,394,868 discloses formation of isocyanurates ion natural oil polyol based polyurethane foams, such as in soybean oil based polyurethane foams, by adding a catalyst for trimerization of the excess isocyanates.

It is known in the art that isocyanurates improve the properties of polyurethane foams. For example, U.S. Pat. Nos. 5,151,216; 4,568,701; 4,036,792 and 4,033,908 disclose that isocyanurates improved temperature resistance in rigid polyurethane foams. And U.S. Pat. No. 4,126,742 describes a process for preparing high-modulus polyisocyanurate elastomers with high temperature resistance. The elastomers are useful in the preparation of high modulus molded parts.

Increased temperature resistance is desirable in polyurethane polymers, While the polyurethane linkage per se may be stable to 180-200° C. (355-395° F.) (Szycher, Michael, Szycher's Handbook of Polyurethanes, CRC Press: Boca Raton, 1999, pp 2-8), polyurethane polymers contain other reaction products such as allophanates which can thermally dissociate as low as 85-120° C. (185-250° F.) (Szycher, Michael, vide supra), giving a maximum use temperature of polyurethane polymers of about 121EC (250° F.) (Pruett, K. M., Chemical Resistance Guide for Elastomers III, Compass Publications: La Jolla, 2005, p767.

However, the benefits, such as increased temperature resistance, conferred by isocyanurates, to polyurethane polymers always come with the cost of excess isocyanates, and one or more of added catalysts and solvents. For example, U.S. Pat. No. 8,067,480 describes porous polyisocyanate poly-addition products produced in the presence of a solvent. And U.S. Pat. No. 3,382,116 discloses preparation of polyisocyanurate solid solutions using lithium perchlorate and an organic solvent. The lithium perchlorate catalyzes the trimerization of the polyisocyanates. And U.S. Pat. No. 4,386,167 discloses preparation of solid polyisocyanurate polymers by polyisocyanate trimerization in organic solvent.

### SUMMARY OF THE INVENTION

The instant invention provides a method for synthesizing a soy-based thermosetting resin, or high temperature organic polymer material, by non-solvent based trimerization of polyisocyanates at room temperature, wherein a hard solid polyisocyanurate-polyurethane polymer product is spontaneously formed. According to this method, a quantity of soy-based polyol is mixed with a quantity of polyisocyanate, at room temperature and in the absence of either added solvent or added catalyst.

In a first embodiment, a method of making a soy-based polyisocyanurate solid thermosetting polymer material is provided, including mixing one equivalent of a soy polyol with at least 3 equivalents of a polyisocyanate at a temperature of at least room temperature and forming a soy-based polyisocyanurate solid thermosetting polymer material that is characterized by resistance to high temperatures and has a high hardness.

In an aspect of the first embodiment, the soy polyol includes a hydroxyl functionality, on average, of approximately two or more hydroxyl groups. In another aspect of the invention, the polyisocyanate is at least one of an aromatic diisocyanate, an aliphatic diisocyanate, an aromatic triisocyanate, an aliphatic triisocyanate and a polymeric isocyanate.

In a further embodiment, an isocyanate terminated pre-polymer is formed. In an aspect of this embodiment, the isocyanate terminated pre-polymer is synthesized from at least one of a petroleum-based polyol and a soy-based polyol. In another aspect of this embodiment, the isocyanate terminated pre-polymer is synthesized from a petroleum-based polyol, whereby the soy-based polyisocyanurate solid thermoset polymer is characterized by reduced brittleness.

In another further embodiment, a catalyst is added, wherein the catalyst includes at least one of a sodium catalyst, a potassium catalyst, a lithium catalyst, a bismuth catalyst, a zinc catalyst and an amine catalyst.

In a second embodiment, a soy-based polyisocyanurate solid thermosetting resin material is provided, wherein the resin is synthesized by mixing one equivalent of a soy polyol with at least 3 equivalents of a polyisocyanate at a temperature of at least room temperature and forming a soy-based polyisocyanurate solid thermosetting resin that is characterized by hardness and resistance to high temperatures. In an aspect of the second embodiment, the resin is substantially stable at temperatures greater than 125° C. (257° F.), the typical maximum use temperature of polyurethane polymers.

The drawings constitute a part of this specification and include exemplary embodiments of the present invention and illustrate various objects and features thereof.

### BRIEF DESCRIPTION OF THE DRAWINGS

FIG. 1 is a graph illustrating the 3335 IR spectrum of the soy-based polymer of Formula II of the present invention.

FIG. 2 is a temperature resistant and high modulus molded part fabricated by pouring the mixture of Honey Bee 150 and Lupranate MM103 into a mold at room temperature, as described in Example 2, below.

FIG. 3 is a graph illustrating the Storage Modulus, Loss Modulus and Tan Delta of the soy-based polymer of Formula II of the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention.

In a first embodiment, a method of synthesizing, or making, a soybean oil-based, or soy-based, polyisocyanurate solid thermosetting resin, or polymer, is provided, wherein no catalyst or solvent is added to the reaction. The soy-based polyisocyanurate solid thermosetting resin of the instant invention may also be referred to as a high temperature polymer, resin or material.

According to the invention, the soy-based high temperature resin is characterized by being a hard solid polymer and resistant degradation at high temperatures, such as but not limited to temperatures much greater than 125° C. (257° F.), which is the typical maximum use temperature of polyurethane polymers. This resistance to high temperatures makes the soy-based polyisocyanurate containing polyurethane thermosetting resin particularly suitable for plastic manufacturing processes that require a temperature above 125° C. (257° F.), such as but not limited to high temperature potting, molding, and coating processes.

The term “thermosetting resin,” as used herein, is a broad term and is used in its ordinary sense, including, without limitation, a plastic, polymer, resin or polymeric material in a soft solid or viscous state that changes irreversibly into an infusible, insoluble polymer network by curing. Curing can be induced by the action of heat or suitable radiation, or both. A cured thermosetting resin is called a thermoset. It is noted that the International Union of Pure and Applied Chemistry (IUPAC) defines a thermosetting resin as a petrochemical with the above noted characteristics. However, the thermosetting resin of the instant invention is soybean oil-based.

The term “hardness,” as used herein, is a broad term and is used in its ordinary sense, including, without limitation, the hardness of a material, such as a polymer material, that is measured by the Shore Durometer Test. For example, the polymer used to make a tire may have a harness of 60 Shore A, a pencil eraser might have a hardness of 70 Shore A, a leather belt might have a hardness of 80 Shore A, and a shopping cart may be fabricated of a polymer material have a hardness of 100 Shore A.

The term “high hardness,” as used herein, is a broad term and is used in its ordinary sense, including, without limitation, having an hardness about 90 Shore A.

A material is considered to be “brittle” if, when subjected to stress, it breaks without significant deformation (i.e., strain). Brittle materials absorb relatively little energy prior to fracture, even those of high strength. Brittleness can be measured using Izod impact testing or Charpy impact testing. The term “brittleness,” as used herein, is a broad term and is used in its ordinary sense, including, without limitation, to a property applicable to a material if fracture occurs soon after the elastic limit is passed.

The term “hydroxyl functionality,” as used herein, is a broad term and is used in its ordinary sense, including, without limitation, to the average number of —OH groups per molecule, such as a polymer molecule.

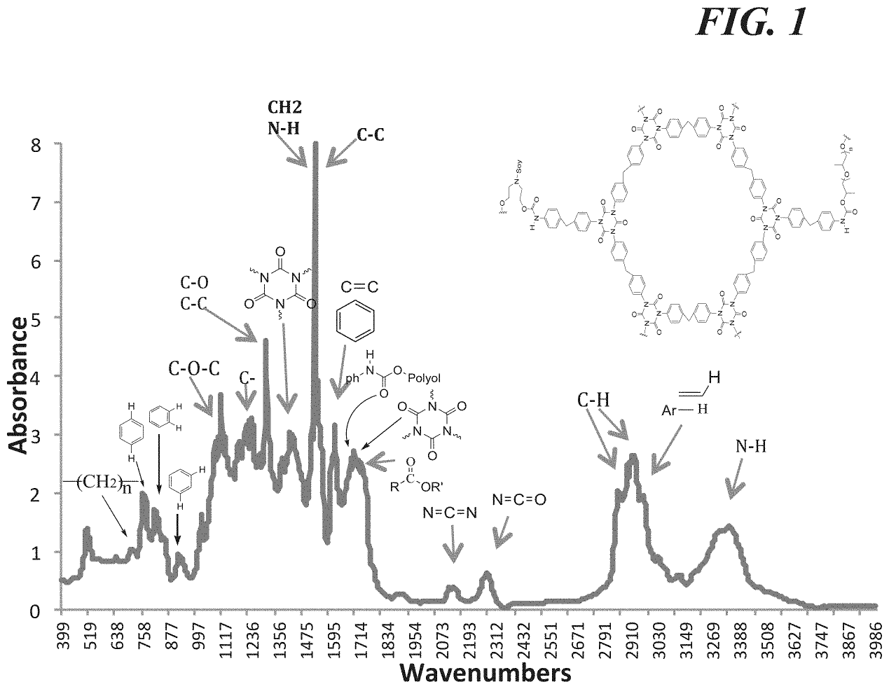

The chemical structure of an exemplary soy-based polyisocyanurate solid thermosetting resin, of the instant invention, is shown in Formula II, below. The 3335 FTIR spectrum of the soy-based polymer is shown in FIG. 1. While this chemical structure is hypothetical, it is consistent with the peak assignments shown in Table 1, below.

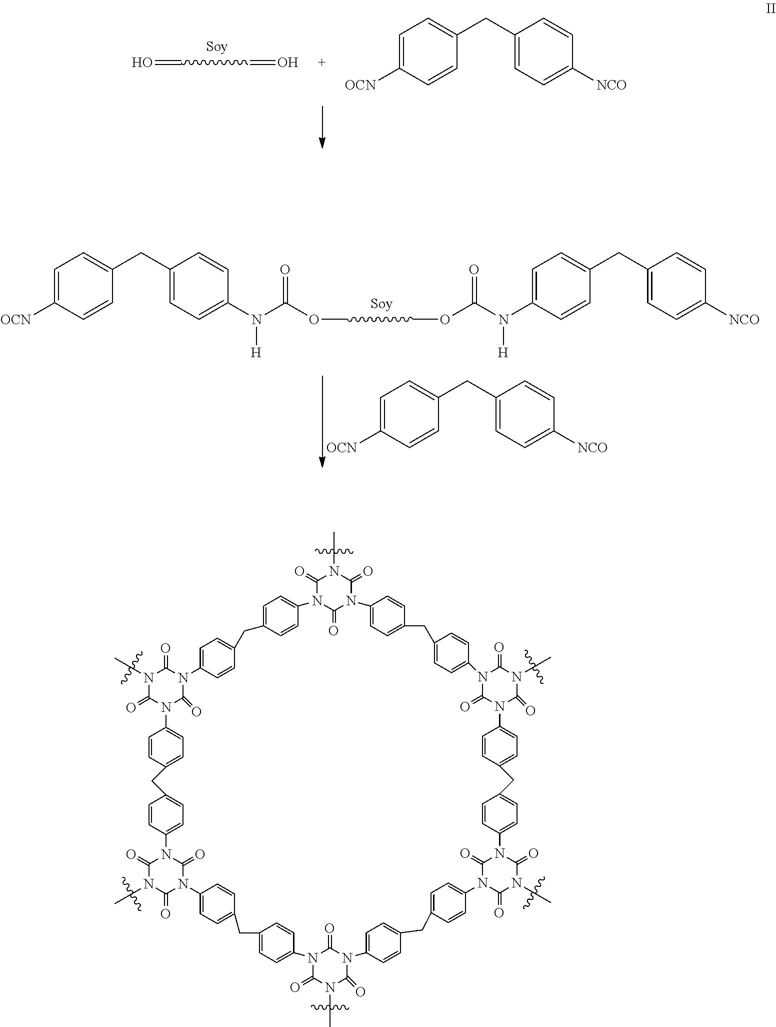

TABLE 1

| Wave- | | | |
|---|---|---|---|
| number | Chemical Group | Cause of Peak | References |
| 3300 cm⁻¹ | 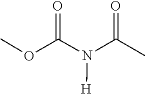 | N—H stretching of urethane groups in 3335 | 1. D. Bhattacharjee and R. Engineer; Journal of Cellular Plastics, 1996, Vol 32 (3), 260-273. 2. C.S. Wong and K.H. Badri, Materials Science and Applications, 2012, Vol. 3, 78-86. |
| 3012 cm⁻¹ | 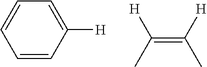 | C—H (sp2 Carbon) stretching of aromatic in MDI parts and alken in soy parts | 1. D.L. Setyaningrum, S. Riyanto and A. Rohman; International Food Research Journal, 2013, vol. 20 (4), 1977-1988. 2. X.X. Du and T.M. Garrett, Polyurethanes Expo, 2008, 63. |
| 2910 cm⁻¹ | 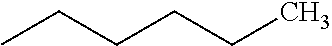 | C—H stretching of —CH₃ in fatty acid chains of soy | 1. K.C. Pradhan and P.L. Nayak, Adv. Appt Sci. Res., 2012, vol. 3(5) 3045-3052. 2. D.L. Setyaningrum, S. Riyanto and A. Rohman; International Food Research Journal, 2013, vol. 20 (4), 1977-1988. |
| 2850 cm⁻¹ | 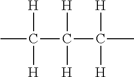 | C—H stretching of > CH₂ in fatty acid chains of soy | 1. K.C. Pradhan and P.L. Nayak, Adv. Appl. Sci. Res., 2012, vol. 3(5) 3045-3052. 2. D.L. Setyaningrum, S. Riyanto and A. Rohman; International Food Research Journal, 2013, vol. 20 (4), 1977-1988. |
| 2260 cm⁻¹ | 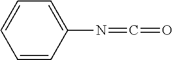 | NCO stretching of unreacted MDI | 1. D. Bhattacharjee and R. Engineer; Journal of Cellular Plastics, 1996, Vol 32 (3), 260-273. 2. J. Zhang, Y.F. Tang and Y. Chen, Asian Journal of Chemistry, 2014, 26(5), 1527-1529. |
| 2100 cm⁻¹ | 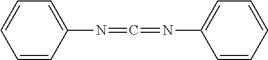 [SMILES: C(=Nc1ccccc1)=Nc1ccccc1] | Carbondiimide stretching | 1. D. Bhattacharjee and R. Engineer; Journal of Cellular Plastics, 1996, Vol 32 (3), 260-273. 2. C.S. Wong and K.H. Badri, Materials Science and Applications, 2012, Vol. 3, 78-86. |
| 1704 cm⁻¹ | 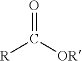 | Carbonyl stretching of soy esters | 1. G.F. Zagonel, P. Peralta-Zamora and L.P. Ramos, Talanta, 2004, vol 63, 1021-1025. 2. C.S. Wong and K.H. Badri, Materials Science and Applications, 2012, Vol. 3, 78-86. 3. K.C. Pradhan and P.L. Nayak, Adv. Appt Sci. Res. 2012, 3(5), 3045-3052. |
| 1678 cm⁻¹ | 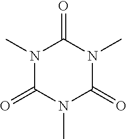 | Ring carbonyl stretching of isocyanurate carbonyl groups, referred to 1,3,5-tris-isocyanatohexameth ylene isocyanurate | 1. D. Bhattacharjee and R. Engineer; Journal of Cellular Plastics, 1996, Vol 32 (3), 260-273. 2. C.S. Wong and K.H. Badri, Materials Science and Applications, 2012, Vol. 3, 78-86. 3. J. Zhang, Y.F. Tang and Y. Chen, Asian Journal of Chemistry, 2014, 26(5), 1527-1529. 4. P.J. Kaste, R.G. Daniel, R.A. Pesce-Rodriguez, M.A. Schroeder, and J.A. Escarsega; Army Research Lab. 1998, p1-57. |
| 1672 cm⁻¹ | 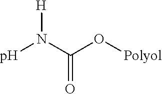 | Carbonyl stretching of urethanes | 1. C.E. Miller and B.E. Eichinger, Applied Spectroscopy, 1990, 44(5), 887-894. 2. C.S. Wong and K.H. Badri, Materials Science and Applications, 2012, Vol. 3, 78-86. 3. Y.A. El-Shekeil, S.M. Sapuan, K. Abdan, E.S. Zainudin and O.M. Al-Shuja’A; Bull. Mater. Sci., 2012, 35(7), 1151-1155. |
| 1604 cm⁻¹ | 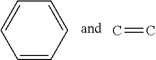 | Carbon-carbon double bond deformation of aromatic ring and alkene | 1. C.H. Tsou, M.C. Suen, W.H. Yao, J.T. Yeh, et al. Materials, 2014, vol. 7, 5617-5632. |
| 1529 cm⁻¹ | C—N | Carbon-nitrogen stretching | 1. K.C. Pradhan and P.L. Nayak, Adv. Appl. Sci. Res. 2012, 3(5), 3045-3052. 2. A.M. Kaminski and M.W. Urban, Journal of Coating Technology, Vol. 69, No. 873, pp 113-121. |
| 1521 cm⁻¹ | N—H | Nitrogen - hydrogen deformation | 1. Y.A. El-Shekeil, S.M. Sapuan, K. Abdan, E.S. Zainudin and O.M. Al-Shuja’A; Bull. Mater. Sci., 2012, 35(7), 1151-1155. 2. A.M. Kaminski and M.W. Urban, Journal of Coating Technology, Vol. 69, No. 873, pp 113-121. |
| 1506 cm⁻¹ | C═C | Carbon-carbon stretching of aromatic MDI | 1. C.S. Wong and K.H. Badri, Materials Science and Applications, 2012, Vol. 3, 78-86. 2. D. Bhattacharjee and R. Engineer; Journal of Cellular Plastics, 1996, Vol 32 (3), 260-273. |
| 1410 cm⁻¹ | 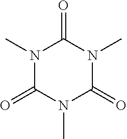 | Isocyanurate ring deformation, the 1410 cm⁻¹ band has a characteristic intensity relative to the 1678 cm⁻¹ ring carbonyl of isocyanurate. | 1. D. Bhattacharjee and R. Engineer; Journal of Cellular Plastics, 1996, Vol. (3), 260-273. 2. C.S. Wong and K.H. Badri, Materials Science and Applications, 2012, Vol. 3, 78-86. 3. J. Zhang, Y.F. Tang and Y. Chen, Asian Journal of Chemistry, 2014, 26(5), 1527-1529. |
| 1304 cm⁻¹ | Ar—N | Carbon-nitrogen stretching aromatic isocyanate isocyanurate | 1. C. Nies, F. Fug, C. Otto, J. Summa, and W. Possart; J. Adhesion, 2013, Vol 89, pp 1-3. |
| 1215 cm⁻¹ | N—C—N | Nitrogen-carbon-nitrogen stretching of isocyanurate | 1. K.C. Pradhan and P.L. Nayak, Adv. Appl. Sci. Res. 2012, 3(5), 3045-3052. |
| 1113 cm⁻¹ | (O═) C—O—C | Carbon-oxygen stretching of urethane | 1. K.C. Pradhan and P.L. Nayak, Adv. Appl. Sci. Res. 2012, 3(5) 3045-3052. |
| 908 cm⁻¹ | 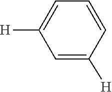 | Carbon-hydrogen bending of meta protons of aromatic isocyanate | 1. Spectroscopy Data Tables, sp2 C—H bend patterns for aromatics |
| 810 cm⁻¹ | 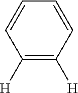 | Carbon-hydrogen bending of ortho protons of aromatic isocyanate | 1. Spectroscopy Data Tables, sp2 C—H bend patterns for aromatics |
| 756 cm⁻¹ | 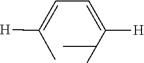 | Carbon-hydrogen bending of para protons of aromatic isocyanate | 1. Spectroscopy Data Tables, sp2 C—H bend patterns for aromatics |
| 708 cm⁻¹ | cis —CH═CH— | cis —CH═CH— bending of soy hydrocarbon chain | 1. D.L. Setyaningrum, S. Riyanto and A. Rohman; International Food Research Journal, 2013, vol. 20 (4), 1977-1988. |

The soy-based solid thermosetting resin shown in Formula II, above, is prepared from a soy-based polyol and 4,4′-methylene-bis(phenydiisocyante). According to the invention, suitable polyisocyanates for synthesizing the soy-based thermosetting resin include, but are not limited to, aromatic diisocyanates, aliphatic diisocyanates, aromatic triisocyanates, aliphatic triisocyanates, polymeric isocyanates and mixtures thereof.

According to the invention, suitable soy-based polyols, or soy polyols, have, on average, two hydroxyl groups (—OH). Generally, the soy-based polyol is synthesized using a non-epoxide synthesis method, such as is described in U.S. Pat. Nos. 7,674,925 and 8,575,294, and U.S. Publication Nos. 2011/0166315 and 2012/0116042, each of which is incorporated herein by reference in its entirety. Briefly, suitable soy-based polyols are synthesized by addition of a designated reactant, N-AH, to olefin groups of the soy oil, wherein N includes at least one nucleophilic functional group and AH is a functional group having at least one active hydrogen or masked active hydrogen. The reaction is catalyzed by an addition reaction in which at least one of the functional groups added in the transition state by the catalyst is a good leaving group (see Formula III, below).

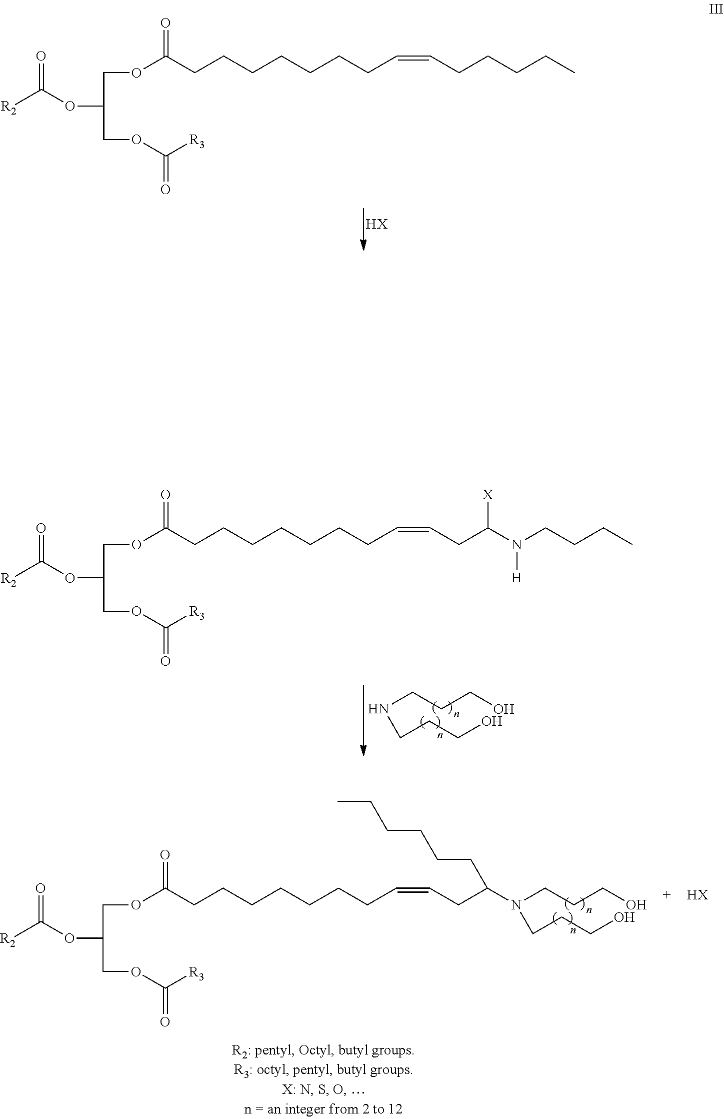

Suitable nucleophilic functional groups for synthesis of the soy polyol include but are not limited to amines, thiols and phosphines. Suitable active hydrogen functional groups according to the invention include but are not limited to amines, thiols and carboxylic acids.

A preferred designed reactant for synthesis of the soy polyol is a polyhydroxylalkyl amine. For example, preferred hydroxyl groups of dihydroxyalkylamines include but are not limited to primary hydroxyl groups such as diethanolamine, and secondary hydroxyl groups such as bis(2-hydroxypropyl)amine. Preferred alkyl groups of dihydroxyalkyamines include those containing 2 to 12 carbon atoms, such as methyl, ethyl, propyl, butyl, pentyl, hexyl, heptyl, octyl, nonyl, decyl, and dodecyl groups. Suitable dihydroxyalkylamines are secondary amines, primary amines, and diamines such as N,N-bis(2-hydroxyethyl) ethylene diamine and N,N:-bis(2-hydroxyethyl) ethylene diamine.

The soy polyol synthesis shown in Formula III is catalyzed by molecules, which upon addition to the plant oil double bonds, yield good leaving groups. Exemplary addition catalysts include, but are not limited to: halogens of the structure X₂ wherein X₂ includes 12, Br₂ and Cl₂, and hydrohalogens of the structure HX wherein HX includes HI, HBr and HCl. The halogen X₂ functions as a starting catalyst and HX as a finishing catalyst. It is believed that the catalysis proceeds in a manner well known to addition chemistry to form an intermediate. The halogen X₂ is added onto the carbon-carbon double bond of the soybean oil molecules. It is believed that the next step proceeds in a manner well known in SN₂ chemistry, replacing the leaving group to form a novel plant polyol. Hydro-halogen HX undergoes addition reaction with a next soybean oil molecule or next fatty acid branch of the soy oil molecule to give a halogenation product, then the halogenated product undergoes replacement reaction with dihydroxyalkylamine to form the soy polyol and HX. The addition reaction and replacement reaction repeats until the designated reactant, e.g., dihydroxylalkylamine, completely disappear. Additional description of this soy polyol synthesis, such as alternative catalysts and reaction conditions, such as temperatures and times, can be found in U.S. Pat. Nos. 7,674,925; 8,541,536; 8,575,294; 8,575,378; 8,882,625; and 8,865,854, each of which is incorporated herein in its entirety. In a preferred embodiment of the invention, the excess acid of the synthesis reaction is neutralized to an acid number of 1 mg KOH/g or below.

Referring again to Formula II, according to the invention, synthesizing the soy-based polyisocyanurate solid thermosetting resin may include synthesizing, or forming, an isocyanate terminated pre-polymer. As used herein, the term “pre-polymer” is a broad term and is used in its ordinary sense, including, without limitation, to a monomer or system of monomers that have been reacted to an intermediate molecular weight state, and is capable of further polymerization by reactive groups to a fully cured high molecular weight state. As such, mixtures of reactive polymers with un-reacted monomers may also be referred to as pre-polymers. The term “pre-polymer” and “polymer precursor” are interchangeable.

Generally, isocyanate terminated pre-polymer is synthesized from a soy-based polyol, such as is described with respect to Formula III. However, in some circumstances, an amount of a petroleum-based polyol is added to the reaction to alter the physical properties, such as for example to increase the molecular weight between the crosslinks (Mc, the molecular weight of a portion of a polymer located between the cross-links), which provides for reduced brittleness of the resulting soy-based polyisocyanurate solid thermoset resin. An alternate route to a larger Mc would be to begin with a higher molecular weight soy-based polyol.

According to the invention, the soy polyol is first converted to isocyanate terminated pre-polymer, after the soy polyol is mixed in with excess polyisocyanates. It is known that the pre-polymer formation reaction is an exothermic reaction. Thus, reaction temperature increases as the reaction proceeds. Generated heat from pre-polymer formation reaction quickly warms up the reaction mixture. Once the temperature reaches the temperature at which initial trimerization occurs, the isocyanate monomers and pre-polymers begin to form polyisocyanurate. The soy-based polyisocyanurate high temperature materials are prepared at normal atmospheric temperature in the invented process.

As discussed above, the soy polyols that are used in the invention are manufactured from soybean oil. It is known that trace quantities of some metals are naturally present in soybeans. When the oil is extracted from the soybeans, some of the metals are also extracted. Since the soybean oil contains trace metals sodium, iron, copper, aluminum, chromium, lead, cadmium, potassium, nickel, zinc, and the like (Journal of the American Oil Chemists Society, 1970, Vol. 47, pp313; Journal of the American Oil Chemists Society, 1981, Vol. 48, pp270; International Journal of Modern Chemistry, 2012, vol. 1, pp28), soy polyols synthesized from this soy oil also contain these trace metals. In some circumstances, small quantities of sodium and potassium may be introduced into the soy polyols during well-known soybean oil refining processes and during the manufacturing process of the soy polyols, such as during neutralization. While not wishing to be bound by theory, it is believed that the trace metals present in the soy polyols can catalyze trimerization of isocyanates.

According to the invention, an amount of a catalyst may still be added, if desired, when the soy-based polyol and the polyisocyanate mixed together. Adding a catalyst to the reaction can increase the rate of product synthesis. According to the invention, suitable catalysts include but are not limited to metals and amine catalysts. Metal catalysts include but are not limited to sodium, potassium, lithium, bismuth and zinc. Amine catalysts include but are not limited to the tertiary amine catalysts, such as DABCO (1,4-diazabicyclo[2.2.2]octane) prevalent in the urethane arts.

In a second embodiment, a soy-based polyisocyanurate solid thermoset polymeric resin material is provided, wherein the resin is synthesized according to the method described above. The polymer is substantially stable or substantially resistant to degradation at temperatures greater than 125° C. (257° F.), the typical maximum use temperature of polyurethane polymers.

As used herein, the term “degradation” is a broad term and is used in its ordinary sense, including, without limitation, refers to polymer degradation, which is known in the art to be a change in the properties, such as but not limited to tensile strength, color and shape, of a polymer or polymer-based product under the influence of one or more environmental factors such as heat, light or chemicals such as acids, alkalis and some salts. These changes are usually undesirable, such as cracking and chemical disintegration of products or, more rarely, desirable, as in biodegradation, or deliberately lowering the molecular weight of a polymer for recycling.

According to the invention, the soy-based polyisocyanurate solid thermoset resin is not an elastomer, but rather may be a glass below about 150° C. (302° F.) (see Formula II for more detail). The polymer resin is hard solid material that is useful in applications, such as manufacturing applications, that require high temperatures. Such applications utilize, among other things, high temperature coatings, high temperature potting compounds and reaction injection molding materials.

According to the invention, the physical properties of soy-based polyisocyanurates, including temperature resistance, are sensitive to ratio of isocyanate and soy polyol. The total isocyanate equivalents employed, per equivalent of soy polyol are greater than or equal to three in the instant invention. The polyol is presumed to form a soft segment, linking together hard segments that contain the isocyanurate groups, such as the poutative structure shown in Formula II. The heat resistance of the invented material was improved by increasing the isocyanate equivalents. However, when the ratio between the isocyanate equivalents and the polyol equivalents is greater than or equal to 18, the invention process gives a brittle product. In such a case, however, as mentioned above, amounts of petroleum based polyols may be included in the reaction so as to reduce brittleness of the thermosetting resin material in the invention, presumably by increasing the molecular weight between crosslinks (Mc).

### EXAMPLES

### Example 1

Two hundred grams (200.0-g; 0.56 equivalents) of the soy polyol Honey Bee 150 (MCPU Polymer Engineering LLC, Corona, Calif., USA) was added to 800.0-g (5.59 equivalents) of 4,4′-methylenebis(phenylisocyanate) Lupranate MM103 (BASF Company Ltd, Seoul, Republic of Korea), with stirring and at room temperature.

Honey Bee 150 is the trade name of a soy polyol that is synthesized from soybean oil according to the method described above with respect to Formula III, and is characterized by having a functionality (e.g., high primary —OH) of 2, a hydroxyl number of 150-mg KOH/gm, ≤0.1% wt. water (maximum), a viscosity (at 77° F.) of 140, and an acidity of ≤3.0-mg KOH/gm.

Lupranate MM103 is the trade name of a solvent-free modification of diphenylmethane-4,4′-diisocanate (MDI), and has an NCO content of 29˜30 wt. %, a viscosity (@ 25° C.) of 25˜50-mPa·s, and a dentigy (@ 25° C.) of 1.22 g/cm³.

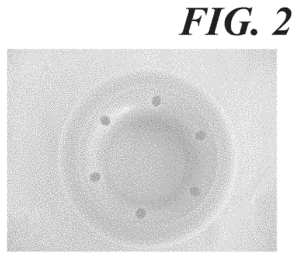

The mixture of Honey Bee 150 and Lupranate MM103 was immediately poured into a mold at room temperature, after de-molded to give a temperature resistant and high modulus molded part shown in FIG. 2.

### Example 2

450.1-g (0.45 equivalents) of petroleum based polyol Arcol LG-56 (Bayer Material Science LLC, Pittsburgh, Pa., USA) was added to 1050.0-g (7.35 equivalents) of 4,4′-methylenebis(phenylisocyanate) Lupranate7 MM103 with stirring.

Arcol LG-56 is the trade name of a petroleum based polyether polyol with a hydroxyl number of 56.2-59.0-mg KOH/g, is 0.05% water by weight, has an acid number of 0.05-mg KOH/g (max).

The reaction mixture was stirred for 2-hours at a temperature of 85° C. to 90° C. The reaction product was cooled to room temperature, and then added to 250.0-g (1.88 equivalents) of triisocyanate polymeric MDI Rubinate® M, to produce a petroleum based isocyanate terminated pre-polymer.

Forty grams (40.0-g; 0.16 equivalents) of soy polyol sold under the trade name Honey Bee 230 (MCPU Polymer Engineering LLC, Corona, Calif., USA) was mixed in 160.0-g (0.80 equivalents) of above isocyanate terminated pre-polymer with stirring at room temperature.

Honey Bee 230 is the trade name of a soy polyol that is synthesized from soybean oil according to the method described above with respect to Formula III, and is characterized by having a functionality (high primary —OH) of 2, a hydroxyl number of 230-mg KOH/gm, ≤0.3% wt. (Max) water, a viscosity (@ 77° F.) of 375, and an acid number of ≤3.0-mg KOH/gm.

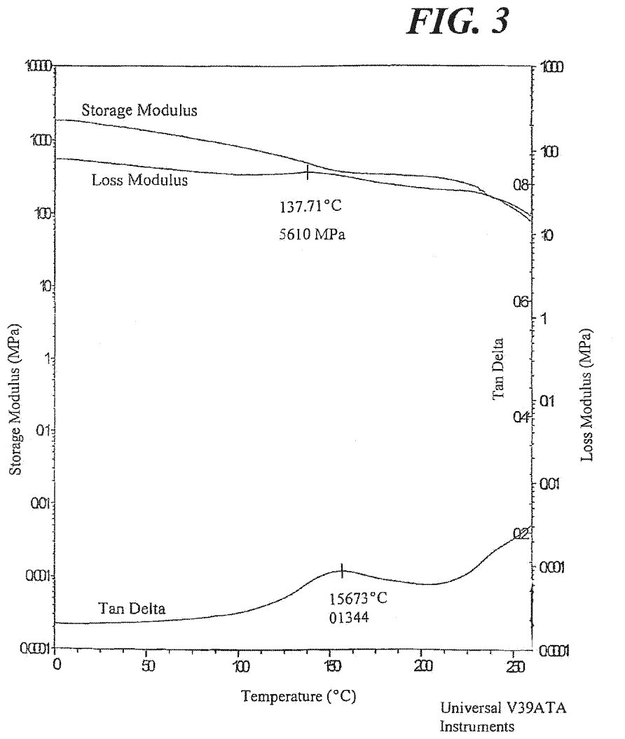

Referring to FIG. 3, the liquid mixture of soy polyol and isocyanate terminated pre-polymer formed a solid within two minutes, and thereby produce a temperature resistant thermoset resin material. The dynamic mechanical analysis (DMA) testing results indicate the cured material has about 100-MPa of storage modulus at 250° C. As is known in the art, the storage and loss modulus in viscoelastic solids measure the stored energy, representing the elastic portion, and the energy dissipated as heat, representing the viscous portion. The storage modulus is a measure of the elastic response of a material but not the same as Young's modulus; also called the in-phase component. The loss modulus is a measure of the viscous response of a material; also called the imaginary modulus or out of phase component. “Tan Data” refers to “tangent delta,” which is the tangent of the phase angle; the ratio of loss to elasticity and an indicator of the viscoelasticity of a sample. Tangent delta is sometimes called damping.

The above description discloses several methods and materials of the present invention. Variations of the methods and materials, as well as alterations in the equipment may be utilized in accordance with the invention and the described examples are not intended to limit the scope of the invention. Such variations will become apparent to those skilled in the art from a consideration of this disclosure or practice of the invention disclosed herein. Consequently, it is not intended that this invention be limited to the specific embodiments disclosed herein, but that it cover all variations, modifications and alternatives coming within the true scope and spirit of the invention. It is to be understood that while certain forms of the present invention have been illustrated and described herein, it is not to be limited to the specific forms or configuration of equipment described and shown.

All references cited herein, including but not limited to published and unpublished applications, patents, and literature references, are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

What is claimed and desired to be secured by Letters Patent is as follows:

1. A method of making a soy-based polyisocyanurate solid thermoset polyurethane resin, comprising the steps:
a) providing a soy polyol synthesized by an addition reaction of olefin groups of a soy oil with N-AH, wherein N includes at least one nucleophilic functional group and AH is a functional group having at least one active hydrogen or at least one masked active hydrogen;
b) mixing one equivalent of the soy polyol previously made with at least 3 equivalents of a polyisocyanate at a temperature of at least room temperature;
c) thereby forming within two minutes a soy-based polyisocyanurate solid thermoset polyurethane resin that is a hard solid and resistant to degradation at high temperatures; and
d) the method occurring in the absence of added catalyst.

2. The method according to claim 1, wherein:
a) the soy polyol has a hydroxyl functionality of at least two hydroxyl groups.

3. The method according to claim 1, wherein:
a) the polyisocyanate is at least one of an aromatic diisocyanate, an aliphatic diisocyanate, an aromatic triisocyanate, an aliphatic triisocyanate and a polymeric isocyanate.

4. The method according to claim 1, further comprising the step:
a) prior to the mixing step in claim 1 forming an isocyanate terminated pre-polymer and, thereafter, utilizing the pre-polymer in the mixing step of claim 1.

5. The method according to claim 4, wherein:
a) the isocyanate terminated pre-polymer is synthesized from a group consisting of a petroleum-based polyol, a soy-based polyol and mixtures thereof.

6. The method according to claim 4, wherein:
a) the isocyanate terminated pre-polymer is synthesized from a petroleum-based polyol; whereby
b) the soy-based polyisocyanurate solid thermoset polyurethane resin is less brittle.

7. A soy-based polyisocyanurate solid thermoset material synthesized according to the method of claim 1.

8. The material of claim 7, wherein:
a) the thermoset material is stable at temperatures greater than 125° C. (257° F.).

9. The method according to claim 1 wherein:
a) the soy polyol and polyisocyanate are mixed at room temperature in the absence of added solvent.

10. A method of making within two minutes a soy-based organic polymer material by mixing a soy-based polyol with polyisocyanate at room temperature in the absence of added solvent and the absence of added catalyst.

11. The method according to claim 10 wherein one equivalent of the soy-based polyol is mixed with at least three equivalents of polyisocyanate.
